(19) United States
(12) Patent Application Publication
(10) Pub. No.: US 2006/0028989 A1
(43) Pub. Date: Feb. 9, 2006

(54) Global A/V telecommunications I.A.D. appliance, systems and servers

(76) Inventor: J. Hutton Pulitzer, Addison, TX (US)

Correspondence Address: JACKSON WALKER LLP, 2435 NORTH CENTRAL EXPRESSWAY, SUITE 600, RICHARDSON, TX, 75080, US

(21) Appl. No.: 11/194,851

(22) Filed: Aug. 1, 2005

Related U.S. Application Data
(60) Provisional application No. 11/184,030, filed on Jul. 30, 2004.
(60) Provisional application No. 11/184,031, filed on Jul. 30, 2004.
(60) Provisional application No. 11/184,032, filed on Jul. 30, 2004.
(60) Provisional application No. 11/184,033, filed on Jul. 30, 2004.
(60) Provisional application No. 11/184,035, filed on Aug. 4, 2004.

(51) Int. Cl. H04L 12/26; H04J 3/14

(52) U.S. Cl. 370/232

(57) ABSTRACT

An information appliance includes a network connection, a telecommunications processor connected to the network connection and a video processor connected to the network connection. When information appliance sends a media request through the network connection to a server such that media is sent to the information appliance in response to said media request. On-demand audio-visual programming is provided on a two-way communication device by receiving a request for audio-visual programming from the two-way communication device at a server, connecting the two-way communication device to a content provider and providing audio-visual programming to the two-way communication device. A method of providing advertisements on an A/V telecommunication device includes collecting demographic data with the A/V telecommunication device. The demographic data is provided to a host server. The hose server accumulates and provides the demographic data to a content provider. The A/V telecommunication device then receives media content, where the media content is selected by the content provider in response to the demographic data. A method for incentive based promotion on an A/V telecommunication device includes delivering promotional content to an A/V telecommunication device. User input is requested over the A/V telecommunication device and a response to the input is delivered to the A/V telecommunication device. A method of providing promotional content to an AW telecommunication device is performed by generating media content and providing media content to the A/V telecommunication device. A method of commerce using an A/V telecommunication device is performed by requesting a transaction using the A/V telecommunication device. The transaction request is received by a host server and communicated to a provider. The provider then delivers according to the transaction to a user of the A/V telecommunication device. An information appliance including a network connection, a telecommunications processor connected to the network connection and a video processor connected to the network connection. The information appliance collects data regarding a user of the information appliance. An A/V telecommunication device including a network connection, a telecommunications processor connected to the network connection, and a video processor connected to the network connection may include an integrated interactive promotion. An A/V telecommunication device including a network connection, a telecommunications processor connected to the network connection, and a video processor connected to the network connection may include an integrated incentive promotion manager connected to said telecommunication processor. A method for providing advertising content in A/V messaging for an A/V telecommunication device including a network connection, a telecommunications processor connected to the network connection, and a video processor connected to the network connection may be performed by receiving a call initiation from a caller and recognizing a “no-answer” condition. A content provider sends advertising content to said caller. A message from the caller is then recorded.

### RELATED APPLICATIONS

This application claims priority to U.S. Provisional Patent Application Ser. No. 60/592,651, entitled “HOUSEHOLD BROADBAND INFORMATION APPLIANCE” filed on Jul. 30, 2004, having J. Hutton Pulitzer, listed as the inventors, and Ser. No. 60/598,650, entitled “ON-DEMAND AUDIO VISUAL PROGRAMMING ON A TWO-WAY TELECOMMUNICATIONS DEVICE” filed on Aug. 4, 2004, having J. Hutton Pulitzer, listed as the inventors the entire content of each of which is hereby incorporated by reference.

### TECHNICAL FIELD OF THE INVENTION

The invention relates to the field of video telephony, in particular to an integrated multi-network video telephones.

### BACKGROUND OF THE INVENTION

The combination of video and audio channels provide a unique platform for interpersonal communication. With the availability of broadband Internet network connections in the home, there is an opportunity to provide further methods of interaction between content providers and consumers.

What is needed, therefore, is a system and method of providing a broadband information appliance.

### SUMMARY OF THE INVENTION

An information appliance includes a network connection, a telecommunications processor connected to the network connection and a video processor connected to the network connection. When information appliance sends a media request through the network connection to a server such that media is sent to the information appliance in response to said media request.

On-demand audio-visual programming is provided on a two-way communication device by receiving a request for audio-visual programming from the two-way communication device at a server, connecting the two-way communication device to a content provider and providing audio-visual programming to the two-way communication device.

A method of providing advertisements on an A/V telecommunication device includes collecting demographic data with the A/V telecommunication device. The demographic data is provided to a host server. The hose server accumulates and provides the demographic data to a content provider. The A/V telecommunication device then receives media content, where the media content is selected by the content provider in response to the demographic data.

A method for incentive based promotion on an A/V telecommunication device includes delivering promotional content to an A/V telecommunication device. User input is requested over the A/V telecommunication device and a response to the input is delivered to the A/V telecommunication device.

A method of providing promotional content to an AW telecommunication device is performed by generating media content and providing media content to the A/V telecommunication device.

A method of commerce using an A/V telecommunication device is performed by requesting a transaction using the A/V telecommunication device. The transaction request is received by a host server and communicated to a provider. The provider then delivers according to the transaction to a user of the A/V telecommunication device.

An information appliance including a network connection, a telecommunications processor connected to the network connection and a video processor connected to the network connection. The information appliance collects data regarding a user of the information appliance.

An A/V telecommunication device including a network connection, a telecommunications processor connected to the network connection, and a video processor connected to the network connection may include an integrated interactive promotion.

An A/V telecommunication device including a network connection, a telecommunications processor connected to the network connection, and a video processor connected to the network connection may include an integrated incentive promotion manager connected to said telecommunication processor.

A method for providing advertising content in A/V messaging for an A/V telecommunication device including a network connection, a telecommunications processor connected to the network connection, and a video processor connected to the network connection may be performed by receiving a call initiation from a caller and recognizing a “no-answer” condition. A content provider sends advertising content to said caller. A message from the caller is then recorded.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a household broadband information appliance;

FIG. 1A illustrates a handset for a household broadband information appliance;

FIG. 2 illustrates a block diagram of a household broadband information appliance;

FIG. 3 illustrates a block diagram of a household broadband information appliance;

FIG. 4 illustrates a household broadband information appliance system;

FIG. 5 illustrates a block diagram of a system for providing two-way audio-visual programming on demand;

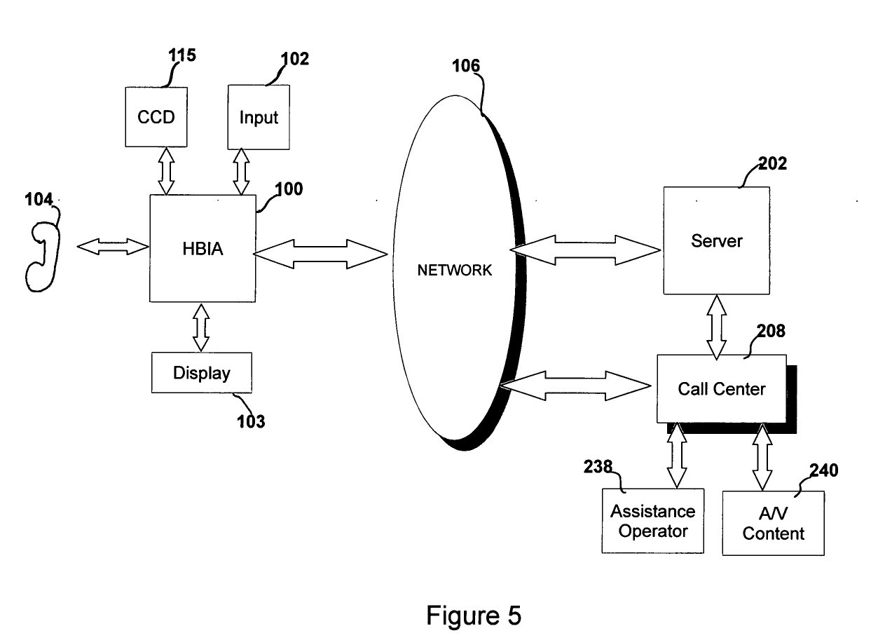

FIG. 6 illustrates a demographic driven advertising system;

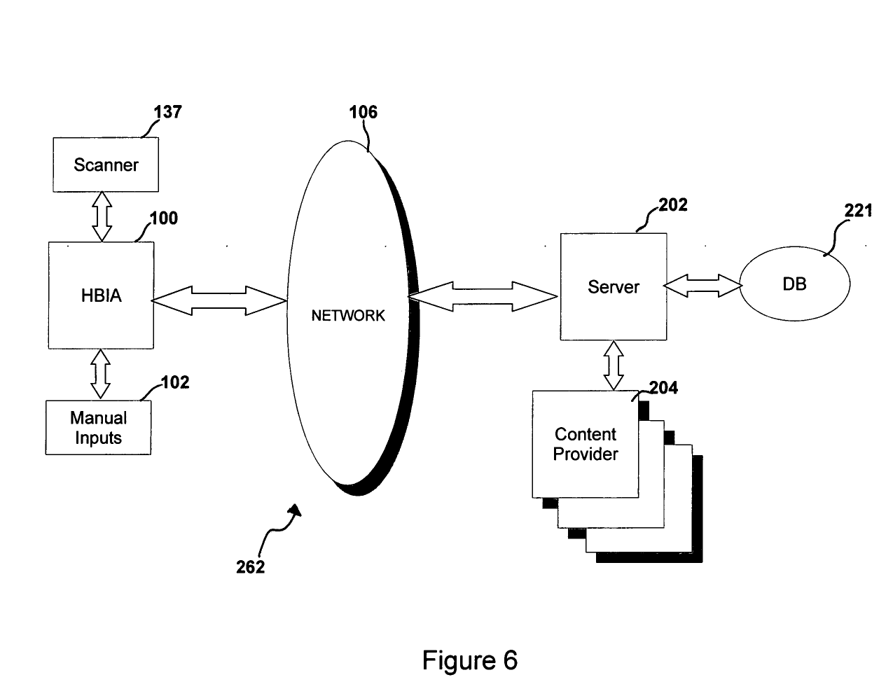

FIG. 7 illustrates a flowchart of incentive based promotion over an A/V telecommunication device;

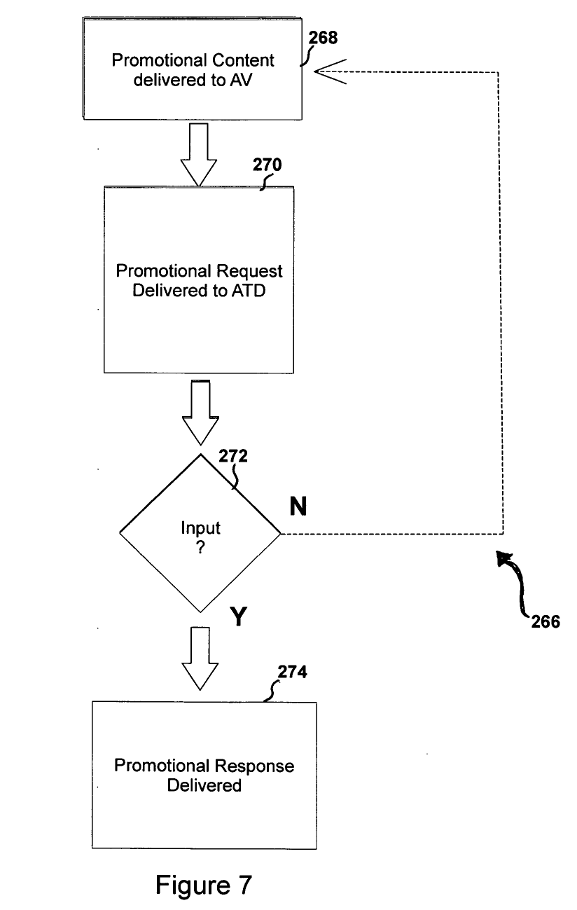

FIG. 8 illustrates a system for providing promotional content to an A/V telecommunication device;

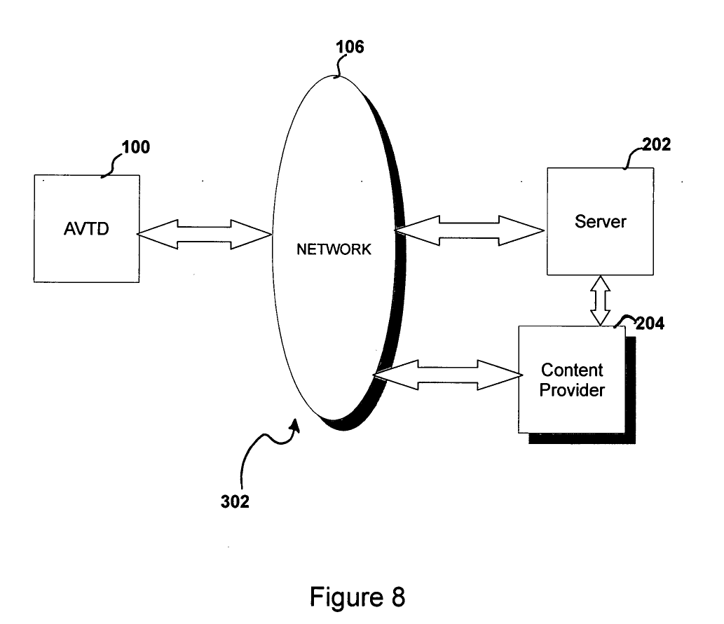

FIG. 9 illustrates a system for commerce using an A/V telecommunications device;

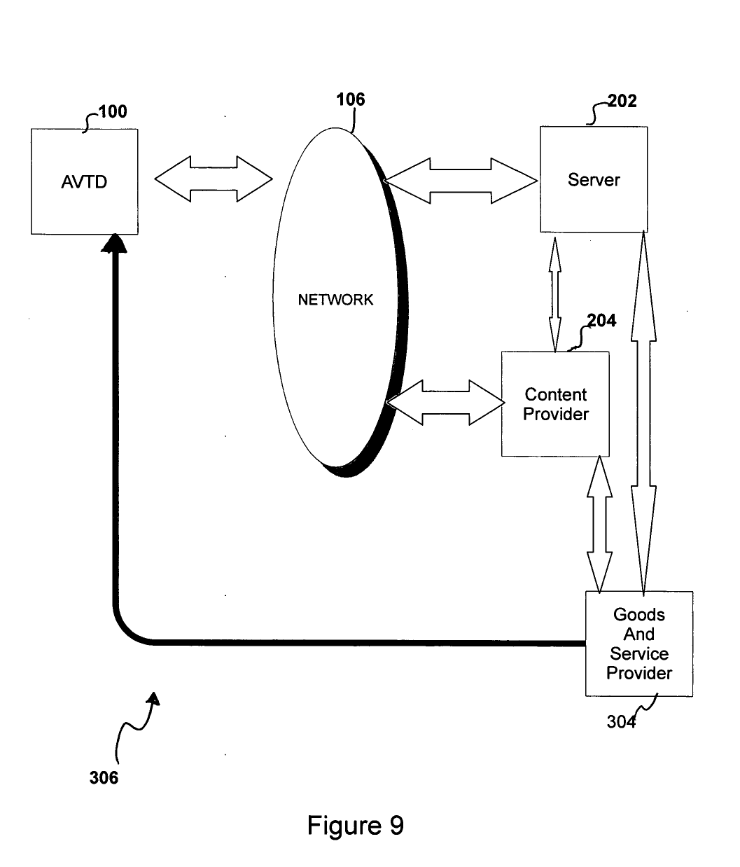

FIG. 10 illustrates an A/V telecommunication system for collecting and processing user data;

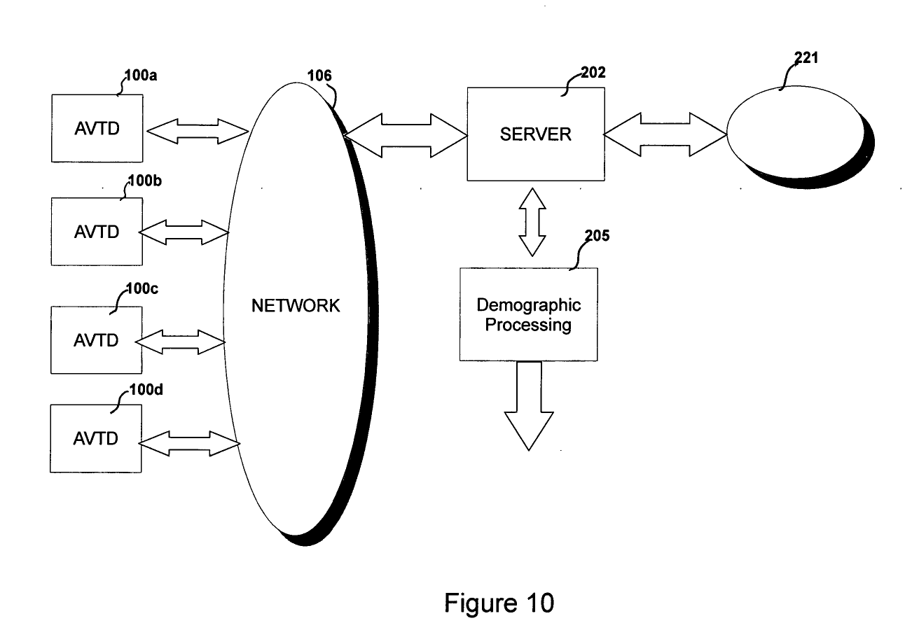

FIG. 11 illustrates a flowchart of an integrated interactive promotion;

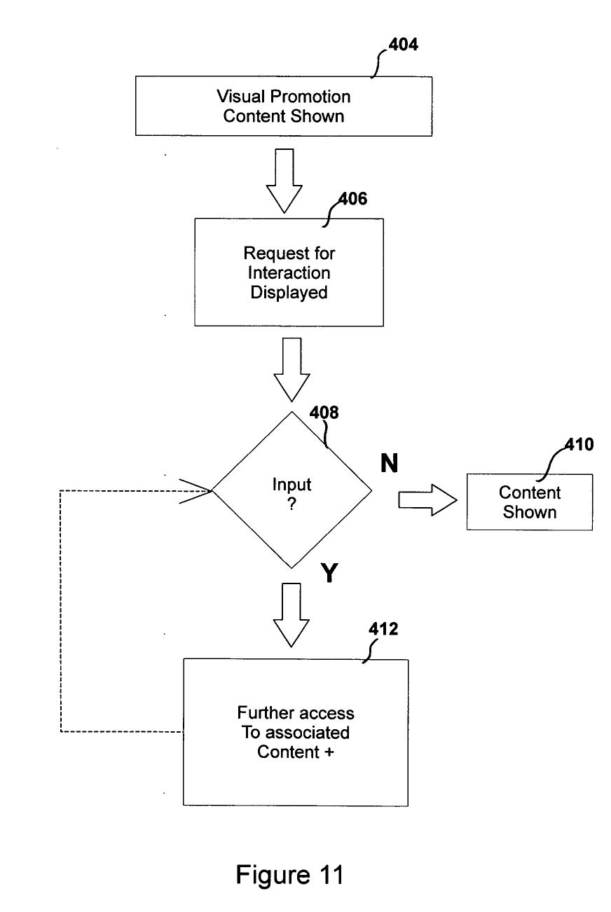

FIG. 12 illustrates an integrated incentive promotion manager; and

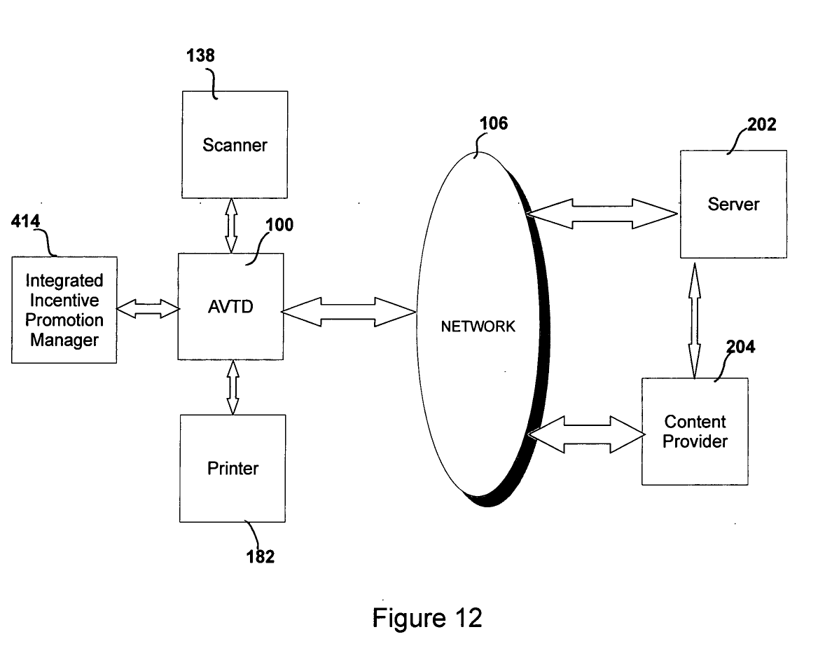

FIG. 13 illustrates a system for providing advertising in messaging.

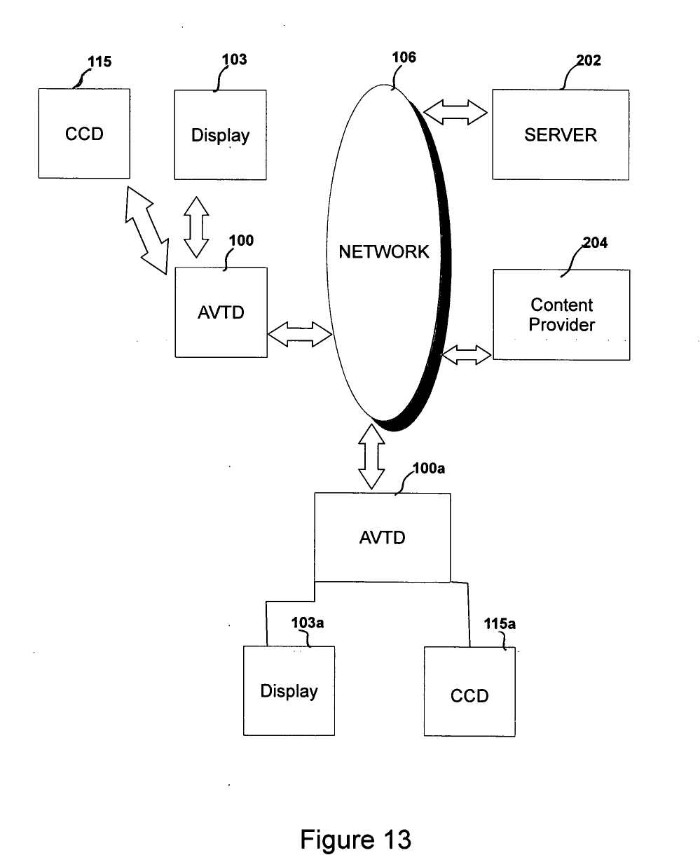

### DETAILED DESCRIPTION OF THE INVENTION

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

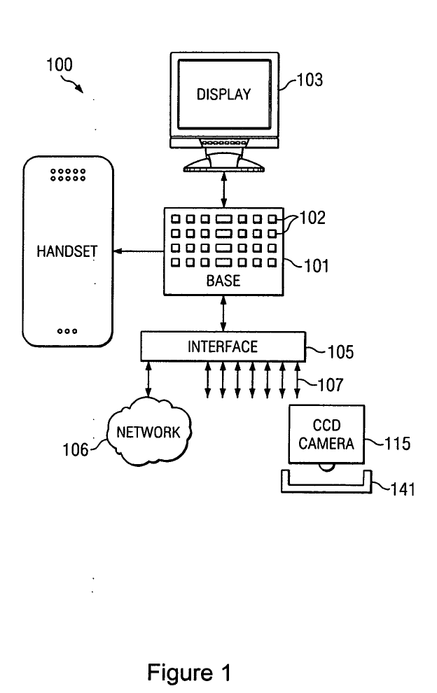

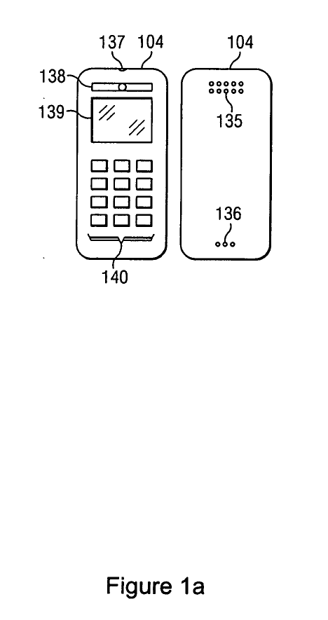

With reference to FIG. 1, a functional depiction of a broadband information appliance 100 is shown. The broadband information appliance 100 includes a base unit 101. The base unit 101 typically houses the processing circuits, memory storage, interfaces 105, manual inputs 102 and power connections. The base unit 101 may be attached to a display 103. The display 103 may be integral with the base unit 101. The display 103 may be an independent unit fixedly attached to the base unit 101. The display 103 may be interchangeably attached to the base unit 101 such that the display 103 may be easily exchanged for a different display 103.

Base unit 101 may include manual inputs 102. Typically the manual inputs 102 may include a standard telephone keypad with ten numeric buttons plus “#” and “*” buttons. The manual inputs 102 may further include any number of other buttons, switches, thumbwheels or other appropriate manual input devices. A wide variety of functions and features may be controlled using the manual inputs 102. Manual inputs 102 may include navigation keys or a joystick for up, down, right and left selections, programmable soft keys. Power and status LEDs may also be provided.

Base unit 101 may be connected to a handset 104. Handset 104 may be substantially a standard telephone handset including a microphone and speaker. Handset 104 may be directly connected to the base unit 101. A handset 104 directly connected to the base unit 101 may be called a “tethered” or “wired” handset. Handset 104 may also include a wireless transceiver for wireless connection to a base unit including (or connected to) a wireless transceiver. The wireless transceivers may be a 2.4 gigahertz transceivers or may use any other suitable wireless transceiver frequency. The wireless transceivers may be spread spectrum transceivers. A handset 104 wirelessly connected to the base unit may be called a “wireless” handset.

Base unit 101 may be connected to an interface 105. Typically, interface 105 will be integral with base unit 101. Interface 105 includes an interface for connection to network 106. Network 106 may be an open network such as the Internet. Interface 105 includes interface connections 107 for connecting the base unit 101 to a variety of peripherals or networks. Typically, the interface 105 will provide Ethernet ports, telephone handset and keypad support, video capture and display ports including NTSC composite input and output ports, S-video ports, NTSC camera ports and LCD display ports. The interface 105 may include audio capture and reproduction ports, an external microphone port, an external speaker port, two audio line level inputs, a handsfree speakerphone,

A digital video camera 115 may be connected to base unit 101. Typically digital video camera 1105 is a CCD camera device. The digital video camera 115 may be integral with the base unit 101 or the display 103. An additional digital video camera 137 may be integral with the handset 104. A privacy shield 141 may be a cover provided to disable the digital video camera 137 by covering the lens of the digital video camera 137.

With reference to FIG. 1A, a more detailed depiction of the features that may be incorporated into handset 104 is shown. The handset 104 typically includes a speaker 135 and a microphone 136 to provide standard audio communication. Handset 104 may include a digital video camera 137, typically at one end of the handset 104. A scanner 138 may be provided on the handset 104 to read machine readable codes or to scan image data. An LCD display 139 may be provided on the handset 104 to allow the user to see the input from digital video camera 137, show video data being shown on display 103 when the handset 104 is being used remotely from the base 101. The handset display 139 may also show alternate visual data. The handset 104 may include further manual inputs 140 to control the video camera 137, handset display 139, scanner 138.

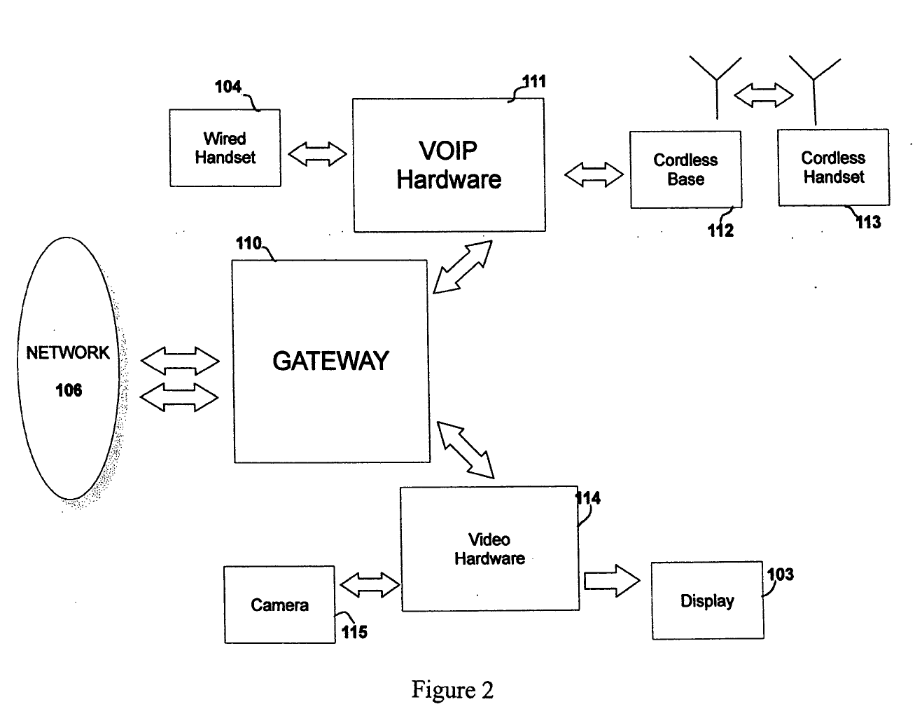

With reference to FIG. 2, a functional block diagram of a basic broadband information appliance 100 is shown. A gateway 110 provides an interface to network 106. The gateway communicates with voice-over-internet-protocol (VOIP) hardware 111 and video hardware 114. The VOIP hardware 114 may be directly connected to wired handset 104 or may be connected to a cordless base unit 112 which provides wireless communication with a cordless handset 113. The video hardware 114 may be connected to a video camera 115 and a display 103.

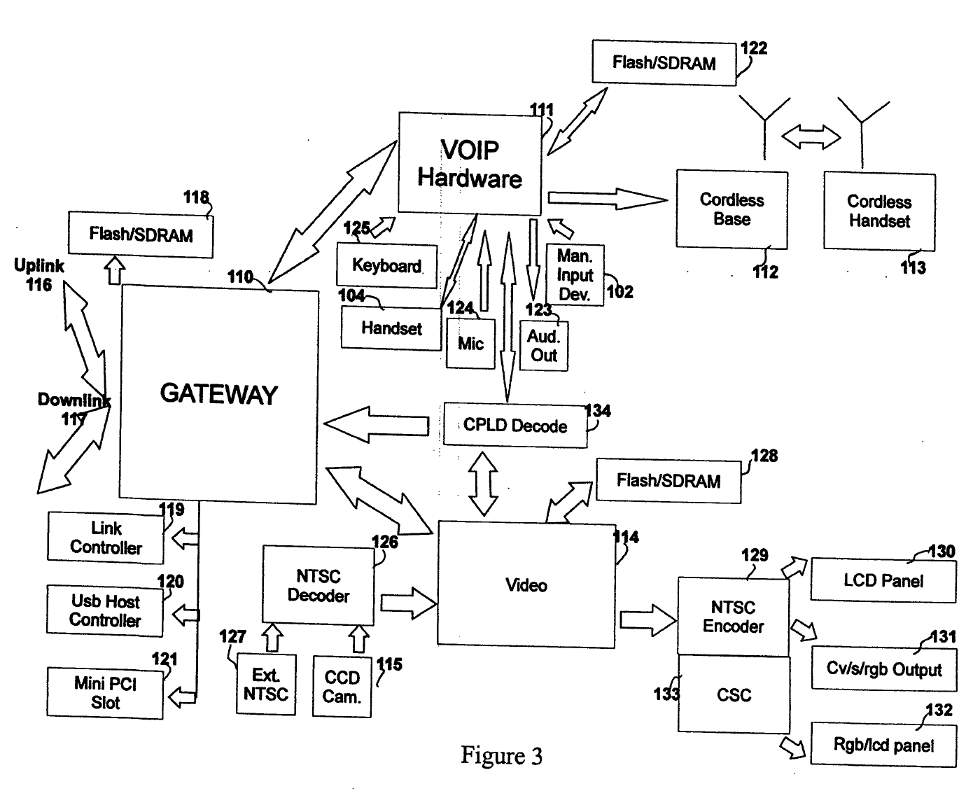

With reference to FIG. 3, a more detailed functional block diagram of a broadband information appliance 100 is shown. A gateway 110 provides communication with one or more networks 106. Gateway 110 may be a Micrel KS8695P processor. The gateway 110 typically acts as the master boot processor for the broadband information appliance 100. The gateway 110 is typically an integrated, multi-port PCI bridge system on a chip. The KS8695P integrates an ARM922T CPU, a PCI bridge that can support up to 3 external PCI masters and a 5-port switch with integrated media access controllers and low power Ethernet PHYs. The PCI interface can be connected gluelessly to miniPCI or cardbus wireless LAN cards that support 802.1 1a/g/b. Those skilled in the art will recognize that other processors, chips or configurations could be used for the gateway 110.

The KS8695P gateway processor includes five Ethernet MAC and PHY, 10/100 Base-Transceivers. It includes a PCI bridge and Master arbiter of up to 3 external PCI 2.1 compliant controllers, supporting a 32 bit data bus as 33 MHz clock speed. The processor includes a memory controller for glueless synchronous DRAM support at 133 MHz access of up to 32 MB, The processor has a standard memory bus for SRAM and flash ROM, 32 bit address, 32 bit data up to 32 MB, with general purpose I/O pins and a JTAG port.

Gateway 110 provides one or more external Ethernet ports. Gateway 110 includes Ethernet ports for both uplink 116 and downlink 117 connections. Typically, uplink 116 and downlink 117 are integrated, however according to some embodiments, separate communication links may be provided for the uplink 116 and downlink 117, particularly where bandwidth limitations make it advisable to provide greater bandwidth for the downlink 117 than the uplink 116.

Gateway 119 may be connected to a link controller 119, a USB host controller 120, a mini-PCI slot 121 or other interfaces. Gateway 119 may be connected to gateway memory 118. Gateway memory 118 may be flash memory, SDRAM or other suitable memory device.

Gateway 119 may be connected to a VOIP processor 111. A VOIP processor 111 is a communication processor for audio codec and telephone management. The VOIP processor 11 may be a Telogy TNETV1050 DSP. The VOIP processor may include a MIPS32 reduced instruction set computer processor and a C55 DSP. The RISC processor software supplies overall system services and performs user interface, network management, protocol stack management, call processing and task scheduling functions. The DSP software provides real-time voice processing functions such as echo cancellation, compression, pulse-code modulation data processing and tone generation and detection.

Two 10/100 Base-T Ethernet MAC and PHY are included with integrated layer-2 three-port Ethernet switches. On-chip peripherals include an 8×8 keypad interface, USB controller host, universal asynchronous receiver/transmitter serial interface, a programmable serial port, several general-purpose input/outputs and integrated voltage regulator.

The integrated dual channel 16-bit voice coder/decoder integrates the critical functions needed for IP phone applications, including two analog-to-digital converters and two digital to analog converters. Other features include analog and digital sidetone control, filter, programmable gain options, a programmable sampling rate, 8-speaker driver, microphone, handset and headset interfaces.

The VOIP processor 111 may include dual Ethernet MAC and PHY, 10/100 base transceivers. The VOEP processor 111 may include a speaker and microphone for handset, headset, and optional input and output sources. The VOIP processor 111 may include a PC and Palm compatible IrDA transceiver, a RS-232 serial port, a USB host port, general purpose I/O pins for LED and configuration options. The VOIP processor 111 may include synchronous DRAM, 133 MHz up to 128 MB, a standard memory bus, a JTAG port and HP Logic analyzer connectors. Those skilled in the art will recognize that other VOIP processors may be used as suitable.

VOIP processor 111 may be connected to a VOIP memory 112. VOIP memory 112 may be a flash memory, SDRAM or other suitable memory devices. The VOIP hardware 111 may be connected to a handset 104 or a cordless base 112 which provides wireless communication with a cordless handset 113. The VOIP hardware 111 may be connected to manual input devices 102, a microphone 124, a speaker 123. VOIP hardware 111 may be connected to an alpha-numeric keyboard 125.

Gateway 110 may be connected to video processor 114. The video processor 114 is a video codec and LCD panel controller. The VOIP processor 111 may be a TI TMS320DM642 digital signal processor. The digital signal processor may be based on the second-generation high-performance advanced VelociTI very-long-word-instruction (VLIW) architecture. The digital signal processor may provide 4800 million instructions per second at a clock rate of 600 MHz. The DSP offers operational flexibility of high speed controllers and the numerical capability of array processors. A DSP core processor has 64 general purpose registers of 32-bit word length and eight independent functional units including two multipliers for 32 bit word length and six arithmetic logic units. The DSP provides extensions in the eight functional units including new instructions to accelerate performance in video and imaging applications to extend parallelism. The DSP can produce four 32-bit multiply accumulates per cycle for a total of 2400 million MACs per second or eight 8-bit MACs per cycle for a total of 4800 million MACs. The DSP may have application specific hardware logic, on-chip memory and additional on-chip peripherals,

The DSP typically uses a two-level cache-based architecture. A Level 1 program cache is a 128-Kbit direct mapped cache and a Level 1 data cache is a 128-Kbit 2-way set-associative cache. A Level 2 memory cache consists of a 2-Mbit-memory space that is shared between program and data space. Level 2 memory can be configured as mapped memory.

The peripheral set may include configurable video ports; a 10/100 Mb/s Ethernet MAC; a management data input/output; a VCXO interpolated control port; a multichannel buffered audio serial port; an inter-integrated circuit bus module; two multichannel buffered serial ports; three 32-bit general purpose timers; a user-configurable 16-bit or 32-bit host port interface; a peripheral component interconnect; a 16-ping general-purpose input/output port with programmable interrupt/even generation modes; and a 64-bit glueless external memory interface which is capable of interfacing to synchronous and asynchronous memories and peripherals.

The DSP may have three configurable video port peripherals. These video port peripherals provide a glueless interface to common video decoder and encoder devices. The DSP video port peripherals support multiple resolutions and video standards. The video ports peripherals are configurable and can support video capture and video display modes. Each video port may include two channels with a 5120 byte capture/display buffer that is split-able between the two channels.

The DSP may include three video ports including a capture port interfaced with a Philips SAA7115 decoder with integrated multiplexer for NTSC, S-video sources; display port interfaced with Philips SAA7105 NTSC and S-video encoder and a third port dedicated to an LCD panel. The DSP may include Ethernet MAC 10/100 Base-Transceivers, The DSP may include general purpose I/O pins and a JTAG port. The DSP may be a synchronous DRAM 64-bit wide, 133 MHz up to 1 GB support. The DSP may include a standard asynchronous memory bus 32 bit. The DSP may include HP logic analyzer connectors for memory bus address, data and control signals. Those skilled in the art will recognize that other DSP processors may be implemented.

The video processor 114 may be connected to a video memory 128. Video memory 128 may be a flash memory, SDRAM or other suitable memory device. The video processor 114 may be connected to an video decoder 126. Video decoder 126 may be a NTSC decoder. Video decoder 126 may receive video signals from an external source 127 or a video camera 115. The video processor 114 may be connected to a video encoder 129. The video encoder 129 may be an NTSC encoder. The video encoder 129 may be integral with a CSC 133 to provide video signals to an RGB/LCD panel 132. The video encoder 129 may provide video signals to an LCD panel 130 and a CV/S/RGB output.

The gateway 110, VOIP processor 111 and video processor 114 may be mutually connected to a CPLD decoder 134.

The broadband information appliance 100 may include smart media access, an infrared transceiver, an unpowered firewire port, fast peripheral ports, a wireless interface, Bluetooth support and a HomePlug interface.

The broadband information appliance 100 may be an AC powered device, using residential power distribution of 120 VAC at 60 Hz or 230 VAC at 50 Hz. A power adapter may convert the AC power to 12 volts DC.

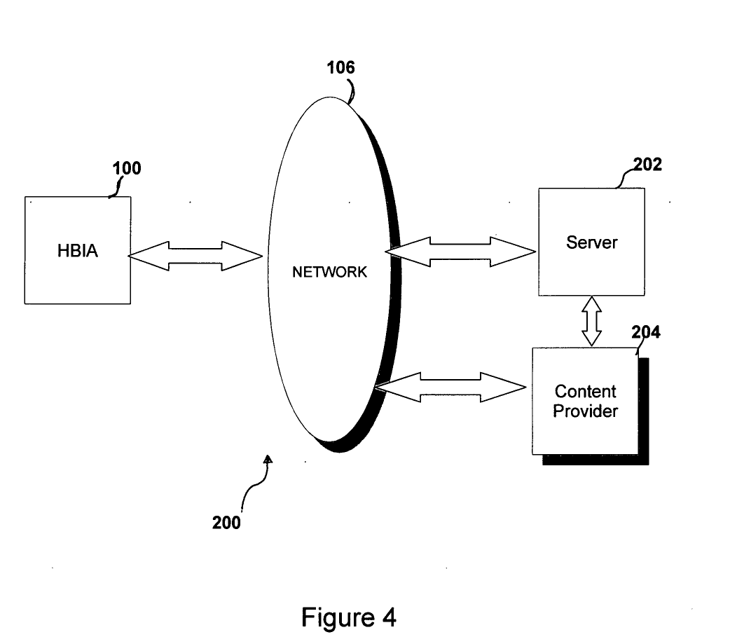

With reference to FIG. 4, a household broadband information appliance system 200 is shown. A household broadband information appliance 100 may be connected to a network 106 such as the Internet with a broadband connection. The network 106 is connected to a host server 202 which manages the information network. The host server 202 is connected to one or more content providers 204. The content provider 204 may be connected directly to the Internet 106.

The household broadband information appliance 100 may send requests for and retrieve various educational, informational and entertainment messages and information. The host server 202 receives the requests from the household broadband information appliance 100. The host server 202 sends a request to the content provider 204. The content provider 204 may provide content to the household broadband information appliance 100 directly through the Internet 106 or through the host server 202.

The content provider 204 may send video, audio, text or other forms of media.

The broadband information appliance typically includes three memory module, particularly the gateway memory 118, the VOIP memory 122 and the video memory 128. SDRAM memory may be connected through each of the direct SDRAM interfaces in the DSP and gateway processors. SDRAM may be rated to operate at 133 MHz and terminated with discrete components. Dedicated SDRAM for each processor may be used.

The household broadband information appliance 100 may send programming requests, scheduling requests or other information requests to the host server 202. The host server 202 processes the received requests and sends appropriate requests to content providers. The host server 202 may store scheduling requests in memory for action at the later, scheduled time. The content provider, here shown as a call center 208, assistance operator 238 and A/V content 240, connects to the household broadband information appliance 100 at the appropriate time to engage the consumer in a two-way audio-visual communication session. The assistance operator 238 is typically a human operator who may speak to the consumer while a video image of the assistance operator 238 is shown on display 103. The assistance operator 238 may transmit A/V content 240 as appropriate. The assistance operator 238 may send e-mail, print material or other forms of communication to the consumer.

With reference to FIG. 4, a system for providing advertisement to a A/V telecommunication device 100 in response to demographic information 262 is shown. The A/V telecommunication device 100 collects demographic information from the users by means of a scanner 137 which may read machine readable codes or provide other forms of scanned data and manual inputs 102. The demographic data is sent to the host server 202 over network 106. Host server 202 may accumulate the demographic data in a database 221. The demographic data may be processed by the host server 202. The server 202 may provide the demographic data to content providers. Content providers 204 provide media content to the A/V telecommunication device in response to the demographic data. The demographic data may result from the scan of codes associated with print advertisements, codes associated with purchased products, codes input from other media sources, acknowledgments or requests for further information of media content displayed on the A/V telecommunication device.

With reference to FIG. 4, a flowchart of a process 266 for providing incentive-based promotions on an A/V telecommunication device 100. Content providers may wish to provoke consumer responses, in the form of simple acknowledgements, data inputs, scanned data inputs, voting or other forms of interactive promotions. Promotional content is delivered to the A/V telecommunication device 100 at function block 268. A promotional request for consumer action is delivered at function block 270. The A/V telecommunication device monitors the inputs 102 to determine if there has been an input at decision block 272. If there is no input, the process follows the NO path to function block 268 where further promotional content is delivered. If an input is detected, the process follows the YES path to function block 274 where a promotional response is delivered. The promotional response may be further promotional material, a connection to a human operator, entry into a contest, the mailing of a paper coupon, email or any other suitable response to the input.

With reference to FIG. 4, a system for providing promotional content to an A/V telecommunication device 100 is shown. In this embodiment, a content provider generates media content including audio or video programming such as advertisements, informational or educational content, entertainment content, interactive communication content or other A/V content. In response to a consumer request from the A/V telecommunication device 100 or as determined by the host server 202, the content provider 204 provides the media content to the A/V telecommunication device.

With reference to FIG. 4, a system for conducting commerce 306 using an A/V telecommunication device 100 is shown. An AW telecommunication device 100 sends a request for a product or service to the host server 202 via network 106. A financial transaction may be arranged over the network 106 or may be arranged in any other suitable fashion. The server 202 may arrange the delivery of product or service to the A/V telecommunication device 100 user by communication with a goods or service provider 304. The goods or service provider 304 delivers the purchased goods or services to the user of the A/V telecommunication device 100.

With reference to FIG. 4, an A/V telecommunication system for collecting and processing consumer and demographic data is shown. A/V telecommunication devices 1OOa, 1OOb, 1OOc and 1OOd are connected to network 106 and thereby to server 202 having memory 221. As users of the A/V telecommunication devices 100 collect user data including preferences and habits. The data may be collected by manual inputs, scans or other inputs. The data may be inferred from the users use or choices in using the A/V telecommunication devices. Interactive content may solicit data from users. The server 202 collects the user data from each of the A/V telecommunication devices 1OOa, 1OOb, 1OOc and 1OOd. The user data is processed 205 and may be distributed as appropriate to commercial markets, advertisers or other interested parties.

With reference to FIG. 4, a flowchart of an in integrated interactive promotion is shown. With the A/V telecommunication device 100 functioning, video data may be displayed on display 103. Visual promotional content is displayed at function block 404. The visual promotional content may include a request for interaction in the audio or video. A manual input 102 may change states, for example, begin flashing, to encourage interaction. When the request for interaction is made at function block 406, the A/V telecommunication device determines if an input has been made at decision block 408. Where the user has performed the requested input, the process follows the NO path to function block 410 where additional content is displayed. If the user has provided the requested inputs, the process follows the YES path to function block 412 where the A/V telecommunication device is given further access to the promotional material, by establishing two-way A/V communication with an associate, the display of further media content or a mixture of the two. Further input requests may lead the process to feed back to decision block 408 to check the presence of additional requested inputs.

With reference to FIG. 4, an A/V telecommunication device 100 with an integrated incentive promotion manager 414 is shown. A/V telecommunication device 100 may receive transmissions from content provider 204 or host server 202 via network 106. The transmissions may request inputs from a consumer, such as scanning bar codes of products using scanner 138 of A/V telecommunication device 100. In return for providing the requested inputs, the content provider 204 may provide incentives to the consumer, such as entering the consumer into a contest or transmitting coupons to the consumer, perhaps to be printed on printer 182 of A/V telecommunication device 100.

With reference to FIG. 4, an A/V telecommunication system for providing advertising in A/V message recording and playback. When an AVTD 1OOa initiates an A/V telecommunication session with AVTD 100 via network 106 in cooperation with server 202, a call notification is played on AVTD 100. If there is no answer at AVTD 100, server 202 notifies content provider 204. Content provider sends advertising content to AVTD 1OOa, including a request for message recording. The user at AVTD 1OOa may record a message using CCD camera 115. The recorded message may be stored at server 202 or some other appropriate location.

It will be appreciated by those skilled in the art having the benefit of this disclosure that this invention provides a broadband information appliance. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. An information appliance comprising:
a network connection;
a telecommunications processor connected to the network connection;
a video processor connected to the network connection;
wherein said information appliance sends a media request through the network connection to a server such that media is sent to the information appliance in response to said media request.

2. A method of providing on-demand audio-visual programming on a two-way communication device including a network connection, a telecommunications processor connected to the network connection and a video processor connected to the network connection, comprising the steps of:
receiving a request for audio-visual programming from the two-way communication device at a server;
connecting said two-way communication device to a content provider; and
providing audio-visual programming to the two-way communication device.

3. A method of providing advertisements on an A/V telecommunication device comprising the steps of:
collecting demographic data with the A/V telecommunication device;
providing the demographic data to a host server; and
providing the demographic data to a content provider receiving media content at the A/V telecommunication device, where said media content is selected by said content provider in response to said demographic data.

4. A method for incentive based promotion on an A/V telecommunication device comprising the steps of:
delivering promotional content to an A/V telecommunication device;
requesting user input over the A/V telecommunication device; and
responding to user input over the A/V telecommunication device.

5. A method of providing promotional content to an A/V telecommunication device comprises the steps of:
generating media content; and
providing media content to the A/V telecommunication device.

6. A method of commerce using an A/V telecommunication device comprising the steps of:
requesting a transaction using the A/V telecommunication device;
receiving said transaction request by a host server;
communicating said transaction request to a provider; and
delivering according to the transaction by the provider to a user of the A/V telecommunication device.

7. An information appliance comprising:
a network connection;
a telecommunications processor connected to the network connection; and
a video processor connected to the network connection.

8. An information appliance comprising:
a network connection;
a telecommunications processor connected to the network connection;
a video processor connected to the network connection; and
wherein said information appliance collects data regarding a user of the information appliance.

9. An A/V telecommunication device comprising:
a network connection;
a telecommunications processor connected to the network connection;
a video processor connected to the network connection; and
an integrated interactive promotion.

10. An A/V telecommunication device-comprising:
a network connection;
a telecommunications processor connected to the network connection;
a video processor connected to the network connection; and
an integrated incentive promotion manager connected to said telecommunication processor.

11. A method for providing advertising content in A/V messaging for an A/V telecommunication device including a network connection, a telecommunications processor connected to the network connection, and a video processor connected to the network connection, said method comprising:
receiving a call initiation from a caller;
recognizing a “no-answer” condition;
sending advertising content to said caller; and
recording a message from said caller.
